(19) United States
(12) Patent Application Publication
(10) Pub. No.: US 2011/0198309 A1
(43) Pub. Date: Aug. 18, 2011

(54) Closure system for a children's drinking bottle or a children's drinking cup

(75) Inventors: Eckhard Itzek, Gyhum-Nartum (DE); Bjoern Frederik Seidler, Scheessel (DE); Reiner Pils, Kalbe (DE); Celine Mialet, Muenchen (DE); Bertrand Coutellier, Hamburg (DE)

(73) Assignee: MAPA GMBH GUMMI- UND PLASTIKWERKE, Zeven (DE)

(21) Appl. No.: 12/597,675

(22) PCT Filed: Apr. 22, 2008
(86) PCT No.: PCT/EP08/03231

§ 371 Date: Mar. 4, 2011

(30) Foreign Application Priority Data
Apr. 27, 2007 (DE) 20 2007 006 080.7
Jul. 6, 2007 (DE) 20 2007 009 607.0

(51) Int. Cl. A61J 9/00

(52) U.S. Cl. 215/11.1; 215/280

(57) ABSTRACT

Closure system for a children's drinking bottle or a children's drinking cup comprising
a sealing ring which has on an external periphery a fastening means for sealingly and releasably connecting to a container edge of a container of the children's drinking bottle or the children's drinking cup, an aperture for receiving a mouthpiece and/or a blind lid and an internal thread, which borders the aperture and is arranged at a distance from the aperture and the fastening means and
a fixing insert with a through aperture and an external thread which may be screwed into the internal thread of the sealing ring in order to clamp sealingly a fastening attachment of the mouthpiece and/or the blind lid between the fixing insert and the sealing ring.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The invention relates to a closure system for a children's drinking bottle or for a children's drinking cup as well as a children's drinking bottle or a children's drinking cup which is provided with a closure system.

Such children's drinking bottles or cups have a container for receiving the liquid. The container is closed by a lid which has a special mouthpiece which simplifies drinking.

For example, children's drinking cups are known in which a lid made in one piece from a relatively rigid plastics is provided with a drinking spout formed integrally with the lid. For easy drinking, the lid is provided with a ventilation hole. To prevent an undesired outflow of liquid, the mouthpiece may be provided with a special insert made of a resilient material with a slit-shaped aperture which only discharges the liquid by sucking on the mouthpiece. A specific valve may also be provided for the same purpose. A drawback with the known children's drinking cups is that the mouthpiece consists of the same, relatively rigid plastics as the remainder of the lid and that the entire lid has to be replaced when the mouthpiece is worn.

In known children's drinking bottles, the mouthpiece is generally a teat made of a very resilient material, such as latex or silicon, which has a fastening flange on the end remote from the aperture. The fastening flange is pressed by a sealing ring, which is screwed to the drinking bottle, against the edge of the drinking bottle. The mouthpiece may be removed from the sealing ring and may, therefore, be separately replaced. The publication DE 197 39 911 A1 shows, for example, such a children's drinking bottle. The correct and sealing fit of the fastening flange of the mouthpiece between the neck of the bottle and the sealing ring may only be monitored with difficulty from the outside. Moreover, the size of the aperture of the neck of the bottle has to correspond to the predetermined size of the fastening flange of the mouthpiece.

Proceeding therefrom, it is the object of the invention to provide a closure system for a children's drinking bottle or a children's drinking cup which simplifies handling and allows flexible use.

### BRIEF SUMMARY OF THE INVENTION

Advantageous embodiments are provided in the sub-claims.

The closure system according to the invention comprises
a sealing ring which has on an external periphery a fastening means for sealingly and releasably connecting to a container edge of a container of the children's drinking bottle or of the children's drinking cup, an aperture for receiving a mouthpiece and/or a blind lid and an internal thread, which borders the aperture and is arranged at a distance from the aperture and the fastening means, and
a fixing insert with a through aperture and an external thread which may be screwed into the internal thread of the sealing ring in order to clamp sealingly a fastening attachment of the mouthpiece and/or of the blind lid between the fixing insert and the sealing ring.

The fastening means of the sealing ring may be a peripheral edge which encompasses the container edge. The sealing ring may, as a result, be positively fixed to the container edge. The container edge may be provided with a peripheral bead which is engaged from behind by a portion of the fastening means in the manner of a snap closure. Also a screw connection is possible between the sealing ring and the container edge. The aperture in the sealing ring may be arranged centrally or laterally offset. Preferably, the aperture is circular. The internal thread is preferably configured on the side of the sealing ring facing the container, i.e. it is preferably located in the interior of the closed children's drinking bottle and/or the children's drinking cup. The internal thread is located at a distance both from the aperture and from the fastening means on the external periphery of the sealing ring, i.e. it is arranged between said aperture and external periphery. Preferably, the internal thread is arranged concentrically to the circular aperture. The fastening attachment of the mouthpiece may be a fastening flange which forms an annular disc-shaped surface extending substantially perpendicular to a longitudinal axis of the mouthpiece. The fastening attachment of the mouthpiece is sealingly clamped between the fixing insert and the sealing ring. Alternatively or additionally, instead of the mouthpiece a blind lid which closes the aperture of the sealing ring, may be sealingly clamped between the fixing insert and the sealing cap. The combination of the sealing ring, the mouthpiece and/or the blind lid and fixing insert thus forms a unit which in the assembled state is connected to the container filled with a liquid. As a result, it may be easily checked whether the fastening attachment of the mouthpiece sits correctly and is clamped sufficiently tightly, before the container filled with liquid is mounted. As a result of this improved capacity for monitoring, it is avoided that the liquid tips out as a result of a leak. At the same time, the clamping of the fastening attachment may be carried out in a manner which is more controlled and sensitive, whereby excessive stress and premature wear of the fastening attachment may be avoided. The size of the container aperture may be selected irrespective of the size of the mouthpiece. In particular, a cup with a relatively large cup aperture which simplifies the filling and cleaning of the cup, may be combined with mouthpieces in standard sizes, which may also be used for drinking bottles. The closure system, as a result, may be used particularly flexibly. As a result of the screw clamping with the fixing insert, mouthpieces may also be securely clamped to fastening attachments of different thicknesses. In particular, teats of existing drinking bottles may be combined with the closure system. This may simplify the conversion of drinking bottles to larger drinking cups, possibly with different mouthpieces.

In one embodiment, the internal thread of the sealing ring is formed on a tubular portion of the sealing ring, an outer face of the tubular portion being adjacent to an inner face of the container edge. The outer face of the tubular portion may entirely or partially rest against the inner face of the container edge or be located at a short distance therefrom. The outer face of the tubular portion forms a guide of the sealing ring which may simplify the positioning on the container edge. Moreover, the formation of a groove of larger volume between the internal thread and the inner face of the container edge, in which liquid could collect and could make complete emptying of the children's drinking bottle or the children's drinking cup more difficult, is avoided. Optionally, the diameter of the internal thread and the container aperture may be adjusted to one another such that the tubular portion has a wall thickness which saves material.

In a further embodiment, the fixing insert has an annular portion which forms the through aperture and a web spanning the through aperture. The annular portion is dimensioned such that it allows a secure clamping of the fastening attachment. At the same time, a particularly large through aperture results, through which the liquid is able to pass unhindered and which further simplifies the monitoring of the correct fit of the fastening attachment. The web spanning the through aperture is particularly easy to grip and simplifies the screwing-in of the fixing insert.

According to one embodiment of the invention, one side of the annular portion of the fixing insert facing the container in the state screwed into the sealing ring, is terminated approximately flush with a free end of the tubular portion of the sealing ring. The free end of the tubular portion of the sealing ring in this case faces the container interior. As a result of the approximately flush terminating portion, the formation of a recess in the region of the fixing insert and the tubular portion is avoided, which in turn promotes the emptying of the remaining liquid. The term “approximately flush” means that in relation to the length of the tubular portion, the annular portion of the fixing insert or the free end of the tubular portion only projects slightly over the respective other part. The actual resulting position in the screwed-in state is in this case dependent on the thickness of the fastening attachment, so that slight deviations from a completely flush seal may occur. Preferably, the fixing insert and internal thread are adjusted to one another such that the annular portion of the fixing insert does not project inwardly over the tubular portion.

According to one embodiment of the invention, one side of the annular portion of the fixing insert facing the container in the assembled state, is inclined towards the through aperture in the direction of the mouthpiece. The incline leading to the mouthpiece simplifies the complete emptying of the container.

In one embodiment, one surface of the sealing ring facing in the assembled state the fastening attachment of the mouthpiece and/or one surface of the fixing insert facing the fastening attachment of the mouthpiece has a peripheral raised portion, a peripheral edge or a peripheral web which is pressed when screwing-in the fixing insert against the fastening attachment. As a result, a well-defined linear or strip-shaped contact surface is provided which improves the fixing of the mouthpiece and the seal of the connection.

In one embodiment, the internal thread of the sealing ring and the external thread of the fixing insert are designed such that fully screwing-in the fixing insert requires one or two turns. Preferably 1.5 turns are required. As a result, the screwing-in of the fixing insert may be carried out more or less by a single hand movement whilst sufficient clearance remains for fastening attachments of different thicknesses.

In one embodiment, the fastening means of the sealing ring is a further internal thread, which cooperates with an external thread of the container edge. As a result of the screw connection, the sealing ring may be fastened particularly easily to the container edge in a manner which is well sealed. In particular, an inadvertent release of the sealing ring from the container edge during drinking, may be more reliably prevented than with a snap closure.

In one embodiment, a blind lid is provided which closes an aperture of the closure system. The blind lid may be inserted into the aperture of the sealing ring and/or into the through aperture of the fixing insert. The blind lid may have a fastening attachment which may be clamped between the fixing insert and the sealing ring by screwing-in the fixing insert into the sealing ring. The blind lid may have a peripheral latching lug which holds the blind lid in the respective aperture and, as a result, simplifies the screwing-in of the fixing insert when using the blind lid. In this case, the blind lid may be inserted into the aperture of the sealing ring instead of the mouthpiece, or in addition to the mouthpiece when it is inserted into the through aperture of the fixing insert. In both cases, the children's drinking bottle or the children's drinking cup is sealingly closed, for example for transport purposes or for storing carbonated drinks.

According to one embodiment, the closure system comprises a mouthpiece which has a drinking aperture and a fastening portion and may be inserted into the aperture of the sealing ring.

Preferably, the mouthpiece is a drinking teat or a drinking spout. As a result, it may be used both for infants and for toddlers.

In one embodiment, the mouthpiece comprises an axially displaceable closure element which sealingly closes the drinking aperture in a first position and opens the drinking aperture in a second position. Such mouthpieces are known as mouthpieces integrated in a screwable bottle closure, for example from the Swiss patent application CH 681075 A5. As a result of the axially displaceable closure element, simple opening and closing of the aperture is possible in the mouthpiece, in particular using the mouth and/or the teeth.

In a further embodiment, the closure element has a peripheral bead. The peripheral bead is preferably arranged at the end of the mouthpiece facing the user and fixedly connected to the axially displaceable closure element. The bead simplifies the displacement of the closure element using the mouth or the teeth.

In one embodiment, the closure element is of substantially tubular configuration and the mouthpiece has a pin which engages in the first position in a longitudinal portion of the closure element. As a result of the engagement of the pin in the closure element, the drinking aperture is closed in the first position. The substantially tubular closure element may have a uniform internal diameter or a variable internal diameter. Preferably, the internal diameter of the closure element is variable and the closure element has at its end facing the user an internal diameter which is adjusted to the external diameter of the pin. With a pin of uniform external diameter, the internal diameter of the closure element may be enlarged in a portion arranged further towards the bottle, relative to the longitudinal portion adjusted to the diameter of the pin, so that the liquid in the second position of the closure element may flow around the pin through the portion with the enlarged internal diameter. In this second position, the pin does not engage in the longitudinal portion with the internal diameter adjusted to the pin. The construction with a pin and a substantially tubular closure element is particularly simple and achieves a reliable seal of the drinking aperture in the closed state.

The aforementioned object is also achieved by the children's drink bottle or the children's drink cup with the features of claim 15. Advantageous embodiments are provided in the accompanying sub-claims. The children's drinking bottle according to the invention or the children's drinking cup according to the invention has a container which has a container aperture and a container edge and a closure system in one of the embodiments described above.

In one embodiment, the children's drinking bottle or the children's drinking cup is additionally provided with a grip element which is inserted between the container and the sealing ring, is configured integrally with the container or is fastened to a separate fastening means on the container.

In one embodiment, the children's drinking bottle or the children's drinking cup additionally has a sealing cap which may be releasably connected to the sealing ring and covers the mouthpiece. As a result, the mouthpiece is protected from soiling.

The drinking bottle closures known from the Swiss patent application CH 681075 A5 have a screw part which is screwed onto a drinking bottle, in order to connect the closure sealingly with the bottle. Proceeding therefrom, a further object of the invention is to provide a closure system for a drinking bottle which allows a more flexible use.

This object is achieved by the closure system for a drinking bottle or a drinking cup comprising a mouthpiece with the features of claim 18. Advantageous embodiments are provided in the accompanying sub-claims.

The closure system according to the invention may preferably be used for a children's drinking bottle or a children's drinking cup. It comprises a drinking aperture and an axially displaceable closure element which sealingly closes the drinking aperture in a first position and opens the drinking aperture in a second position, the mouthpiece comprising a fastening attachment which may be clamped between a container edge of the drinking bottle or the drinking cup and a sealing ring which may be screwed to the drinking bottle or the drinking cup. In contrast to the so-called push-pull closure systems known from the prior art, in the invention a screw part which is adjusted to a specific neck of a bottle is not required. Instead thereof, a clampable fastening attachment is formed on the mouthpiece. The fastening attachment may, in particular, be a peripheral fastening flange. As a result of the clampable fastening attachment, it is possible to combine the closure system with existing drinking bottles or drinking cups which are provided with a sealing ring which may be screwed to the bottle or to the cup. Such drinking bottles or drinking cups are widely available and are, for example, used for fixing a drinking teat or a drinking spout to a children's drinking bottle. As a result of the closure system according to the invention, they may be combined in a simple manner with a push-pull system. As a result, the opening and closing of the drinking bottle or the drinking cup is simplified.

In one embodiment, the closure element has a peripheral bead. In a further embodiment, the closure element is of substantially tubular configuration and the mouthpiece has a pin which in the first position engages in a longitudinal portion of the closure element. These two embodiments and their advantages have already been explained in connection with the closure system comprising a sealing ring and a fixing insert.

According to one embodiment, the fastening portion is a peripheral fastening flange, the thickness thereof reducing outwardly in the radial direction.

In this case, the thickness of the fastening flange may be reduced uniformly in cross section outwardly, or by forming at least one step. This embodiment may simplify the central insertion of the mouthpiece between a drinking bottle or a drinking cup and a sealing ring and improve the sealing effect.

The above object is also achieved by a drinking bottle or a drinking cup with the features of claim 22. The drinking bottle or the drinking cup according to the invention has a container which may be closed by a closure system described above.

Preferably the drinking bottle or the drinking cup are a children's drinking bottle or a children's drinking cup.

Preferably the sealing ring, the fixing insert, the children's drinking cup, the grip element, the mouthpiece with the displaceable closure element and/or the sealing cap consist of plastics.

### BRIEF DESCRIPTION OF THE SEVERAL VIEWS OF THE DRAWINGS

The invention is described in more detail hereinafter with reference to embodiments shown in the figures, in which:

FIG. 1 shows a perspective view of a children's drinking cup according to the invention,

FIG. 2 shows a cross-sectional view of the children's drinking cup of FIG. 1,

FIG. 3 shows a sealing ring according to the invention in a perspective view,

FIG. 4 shows the sealing ring of FIG. 3 in a plan view from the side,

FIG. 5 shows a cross section through the sealing ring along the plane denoted in FIG. 4 by A-A,

FIG. 6 shows a fixing insert in a perspective view,

FIG. 7 shows the fixing insert of FIG. 6 in a plan view from above,

FIG. 8 shows the fixing insert in cross section along the plane denoted in FIG. 7 by A-A,

FIG. 9 shows the fixing insert in cross section along the plane denoted in FIG. 7 by B-B,

FIG. 10 shows the fixing insert in cross section along the plane denoted in FIG. 7 by C-C,

FIG. 11 shows a closure system with the sealing ring and screwed-in fixing insert, between which a mouthpiece with the axially displaceable closure element is clamped, in a cross-sectional view,

FIG. 12 shows a closure system with a mouthpiece with the axially displaceable closure element for a drinking bottle or a drinking cup in a perspective view obliquely from below,

FIG. 13 shows the closure system of FIG. 12 in a further perspective view obliquely from below,

FIG. 14 shows the closure system of FIGS. 12 and 13 in a further perspective view obliquely from above with a separately shown sealing ring.

### DETAILED DESCRIPTION OF THE INVENTION

While this invention may be embodied in many different forms, there are described in detail herein a specific preferred embodiment of the invention.

This description is an exemplification of the principles of the invention and is not intended to limit the invention to the particular embodiment illustrated.

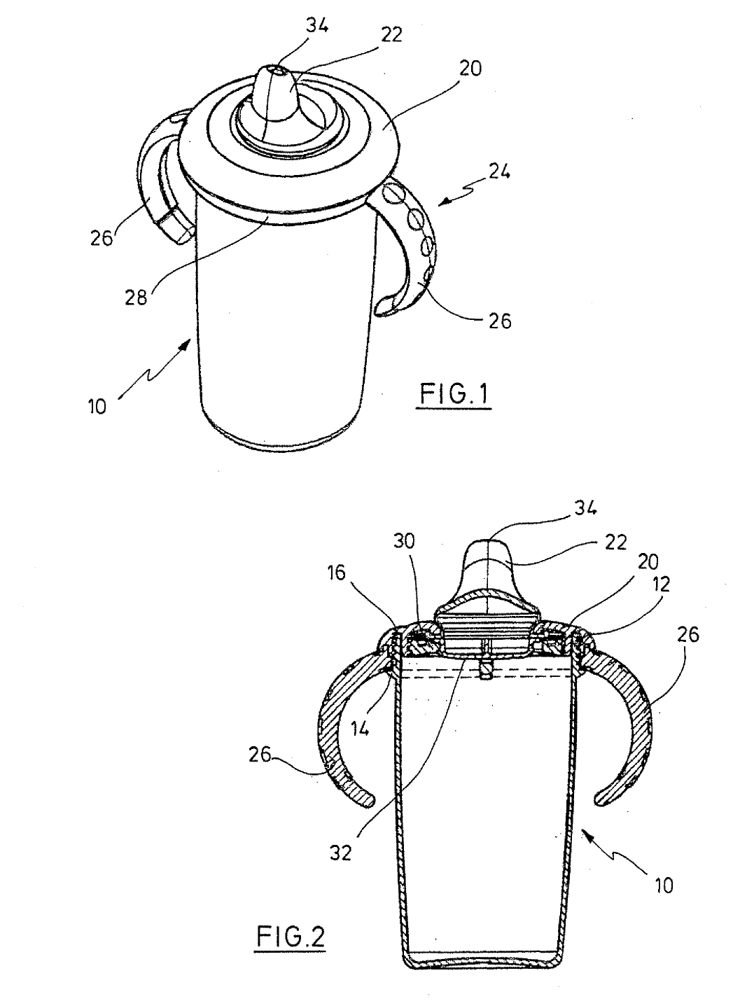

The children's drinking cup of FIG. 1 consists of a cup-shaped container 10 which is closed by a closure system. The closure system consists of a sealing ring 20, in the circular aperture thereof, arranged centrally, a mouthpiece in the form of a drinking spout 22 being inserted. The drinking spout 22 is held by a fixing insert, which is not visible in FIG. 1, in the aperture of the sealing ring 20. Below the sealing ring 20 and also in the region of the cup edge a grip element 24 is arranged which consists of two grip portions 26 and a ring 28 connecting the two grip portions 26.

Further details may be seen more clearly in the cross-sectional view of FIG. 2. The container 10 has a large, circular aperture which extends as far as the upper container edge 16 which is formed by the substantially cylindrically-shaped container wall. An external thread 12 is arranged on the outer face of the container edge 16. Below the external thread 12 is located a peripheral projection 14 which forms a stop. The sealing ring is screwed via an internal thread configured on the external periphery of the sealing ring to the external thread 12. The grip element 24 is fixed between the peripheral projection 14 and the sealing ring 20. Below the drinking spout 22 a blind lid 32 is inserted which is located in a through aperture of the fixing insert 30 and together with a fastening attachment of the drinking spout 22 is clamped between the fixing insert 30 and the sealing ring 20. As a result, the through aperture of the fixing insert 30 is sealingly closed, so that no liquid may run out into the drinking spout 22 and through the aperture 34 thereof.

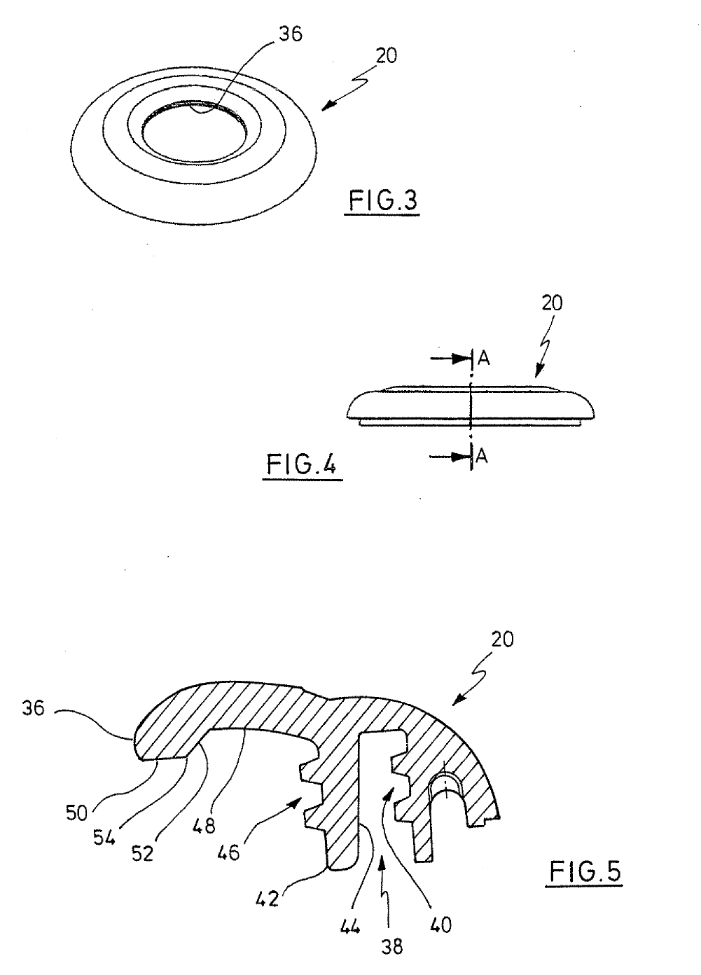

The sealing ring 20 shown in a perspective view in FIG. 3 is annular and has a centrally arranged circular aperture 36. The relatively flat structure of the sealing ring 20 and the very rounded edges on the upper face of the outer periphery are seen in the side plan view of FIG. 4.

FIG. 5 shows a cross section through the sealing ring 20 in a radial cross-sectional plane which is denoted in FIG. 4 by A-A. The edge of the cross section arranged to the left in the figure defines the aperture 36. For connecting to the container 10, the sealing ring 20 is positioned with the peripheral groove shown at 38 on the container edge 16. In this case, the internal thread 40 engages in the external thread 12 of the container edge. The internal thread 40 is formed on the external periphery of the sealing ring 20 and serves as fastening means for the connection to the container 10. On the face of the sealing ring 20 facing the container, and arranged further towards the centre, is located a tubular portion 42, the outer face 44 thereof being adjacent to the container edge of a screwed-in container 10. When screwing-in, the outer face 44 forms a guide for the container edge. On the inner face of the tubular portion 42 a further internal thread 46 is formed. This serves to receive the fixing insert 30. As is visible in FIG. 2, a fixing insert 30 fully screwed into the internal thread 46, is terminated substantially flush with the lower end of the tubular portion 42. Inside the tubular portion 42 the sealing ring 20 has a surface facing the container 48 from which a peripheral web 50 which is adjacent to the aperture 36, projects. The web 50 forms a strip-shaped peripheral contact surface for the clamped retention of the fastening attachment of a mouthpiece. On the external periphery of the web 50, said web projects over a conical surface 52 into the surface 48. Between the strip-shaped contact surface of the web 50 and the conical surface 52 a peripheral edge 54 is formed which is pressed, in a similar manner to the annular surface in the assembled state of the closure system, against the fastening attachment of a mouthpiece. The internal thread 46 is spaced apart both from the aperture 36 and from the further internal thread 40 which forms the fastening means for the container edge. Both spacings extend in the radial direction.

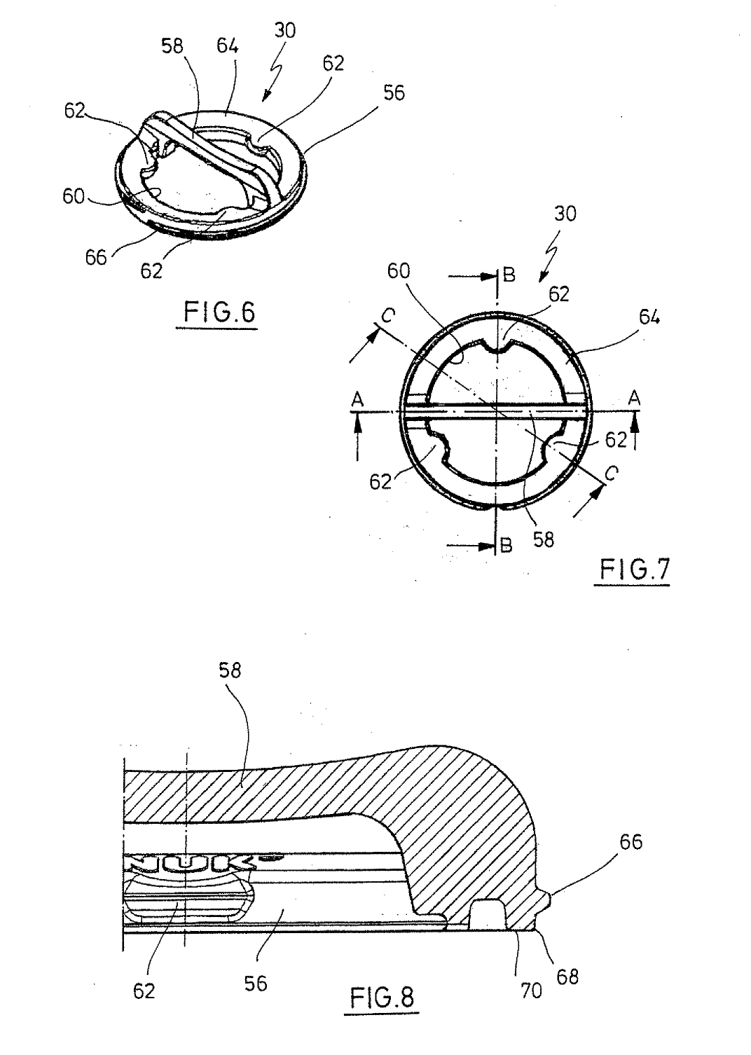

A fixing insert 30 for a closure system according to the invention is shown in FIG. 6 in perspective view. The fixing insert 30 has an annular portion 56 and a web 58. The annular portion 56 has a through aperture 60 which is substantially circular. At three points spaced apart from one another at angles of 120°, circular segment-shaped projections 62 are formed on the annular portion 56 which project into the through aperture 60. The web 58 spans over the through aperture 60. In this case, it extends centrally over the through aperture 60 and is slightly spaced apart in the direction of the longitudinal axis of the annular portion 56 from the plane of the annular portion 56, so that it may be particularly easily gripped. The side 64 of the annular portion 56 facing the container interior in the assembled state is inclined towards the through aperture 60 and in the direction of the mouthpiece.

In the plan view of FIG. 7, the fixing insert is shown again. The arrangement of the circular segment-shaped projections 62 and the web 58 spanning centrally over the through aperture 60 is particularly clearly visible. Moreover, the cross-sectional planes A-A, B-B and C-C are illustrated which provide the views of FIGS. 8 to 10.

In the cross-sectional view of FIG. 8 along the plane denoted in FIG. 7 by A-A, the slightly curved shape of the web 58 spaced apart from the annular portion 56, may be particularly clearly seen. On the outer periphery of the annular portion 56 an external thread 66 is formed, the only thread tooth thereof which projects outwardly, circulating just once about the annular portion 56, as may also be seen in FIG. 6. The outer edge of the annular portion 56 denoted by 68 and the adjacent strip-shaped surface 70 arranged in the plane of the annular portion 56 cooperate in the screwed-together state with the fastening attachment of a mouthpiece and press said fastening attachment against the sealing ring 20.

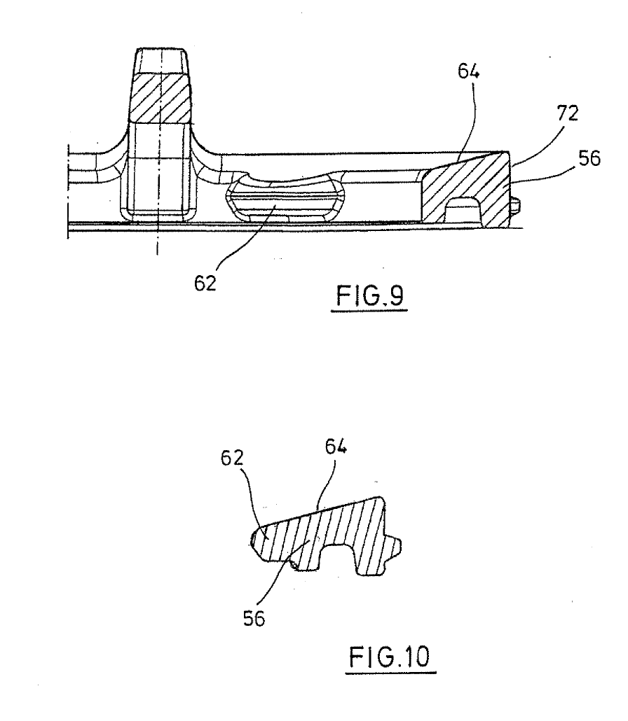

In the cross-sectional view along the plane denoted in FIG. 7 by B-B, shown in FIG. 9, the profile of the annular portion 56 may be particularly easily seen. The incline of the surface 64 in the direction of the through aperture is particularly clear. The approximately cylindrical surface 72 forming the external periphery of the annular portion 56 is adjusted in height to the length of the tubular portion 42 of the sealing ring 20 such that both are terminated approximately flush with one another.

FIG. 10 shows again a cross-sectional view of the annular portion 56 of the fixing insert 30 along the plane denoted in FIG. 7 by C-C in a region with a projection 62 formed thereon. Said projection projects into the through aperture 60 and serves for fixing a blind lid which may be inserted into the through aperture 60. The blind lid, not shown, has a peripheral latching lug which may be engaged behind the projections 62 in order to retain the blind lid.

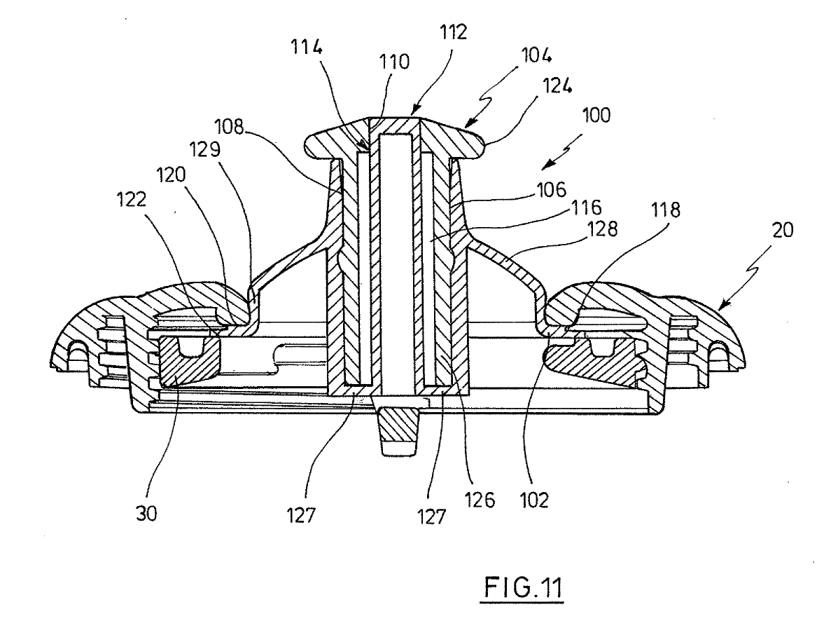

FIG. 11 shows a cross-sectional view of a closure system with a sealing ring 20 and fixing insert 30 between which a fastening attachment 102 of a mouthpiece 100 is clamped. The mouthpiece 100 has an axially displaceable closure element 104 which is substantially tubular and is inserted with its external diameter 108 into an approximately cylindrical aperture 106 of the mouthpiece 100. The internal diameter of the closure element 104 is variable over the length of the displaceable closure element 104 and has in a longitudinal portion 110 facing the user a relatively small diameter which is adjusted to the external diameter of a pin 112 engaging in the portion 110. By the engagement of the pin 112 in the longitudinal portion 110 of the closure element 104 the drinking aperture in the first position shown of the closure element 104 is closed. Below the longitudinal portion 110, the internal diameter of the closure element 104 widens in the region of the step 114 so that below the step 114 a gap 116 is formed between the pin 112 and the internal wall of the closure element 104. On the end of the closure element 104 facing the user, a peripheral bead 124 is located externally which is arranged approximately level with the longitudinal portion 110.

The fastening portion 102 of the mouthpiece 100 has a thickness which reduces outwardly. A step 118 separates two regions of different thicknesses from one another. A contact surface 120 of the sealing ring facing the fastening attachment 102, when clamping the mouthpiece 100 between the sealing ring 20 and the fixing insert 30, is pressed against the thicker portion of the fastening attachment 102 arranged in the radial direction inside the step 118. An upper contact surface 122 of the fixing insert engages, however, in the region of the thinner portion of the fastening flange 102 arranged outside the step 118.

The axially displaceable closure element 104 is guided in an approximately cylindrical housing portion 126 of the mouthpiece 100. This housing portion 126 is connected at the lower end to the lower end of the pin 112 via two webs 127. Moreover, the housing portion 126 is connected via a curved conical housing portion 128 which extends from the external surface of the housing portion 126, and a further substantially cylindrical housing portion 129 to the fastening attachment 102.

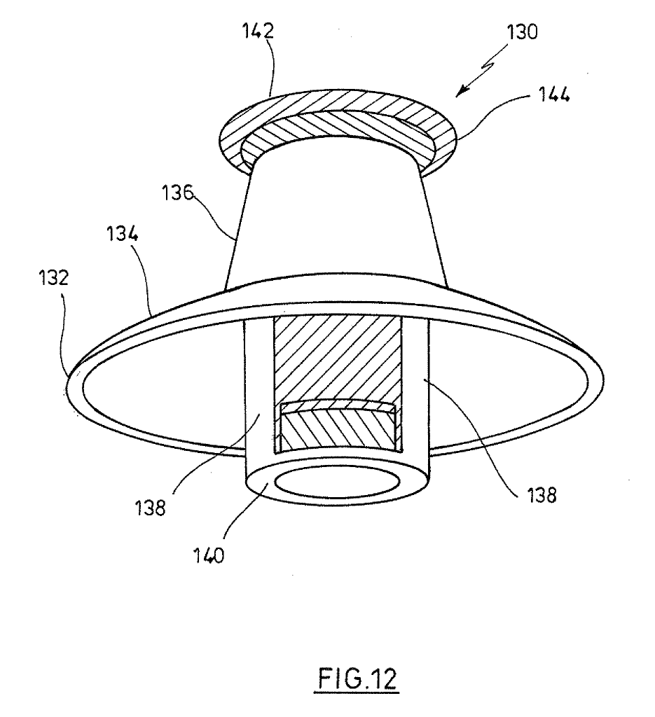

In FIG. 12 a further mouthpiece 130 is shown with a push-pull system. At its outer periphery, the mouthpiece 130 has a fastening attachment 132. The fastening attachment 132 merges with an approximately conical housing portion 134 which merges with a further approximately conical housing portion 136 with an opening angle which is much reduced relative to the housing portion 134. Below the housing portion 134 and fixedly connected thereto, extend two axially aligned webs 138 which at their lower end open into an annular disc-shaped connecting piece 140.

Shown hatched is an axially displaceable closure element 142 which is guided in an approximately cylindrical aperture of the conical housing portion 136. In the first position shown in FIG. 12, the drinking aperture of the mouthpiece 130 is closed. The axially displaceable closure element 142 has a peripheral bead 144 on its end facing the user. The closure element 142 is guided through the conical housing portion 136 and extends below the conical housing portion 134 further in the axial direction between the two webs 138 as far as the annular disc-shaped connecting element 140.

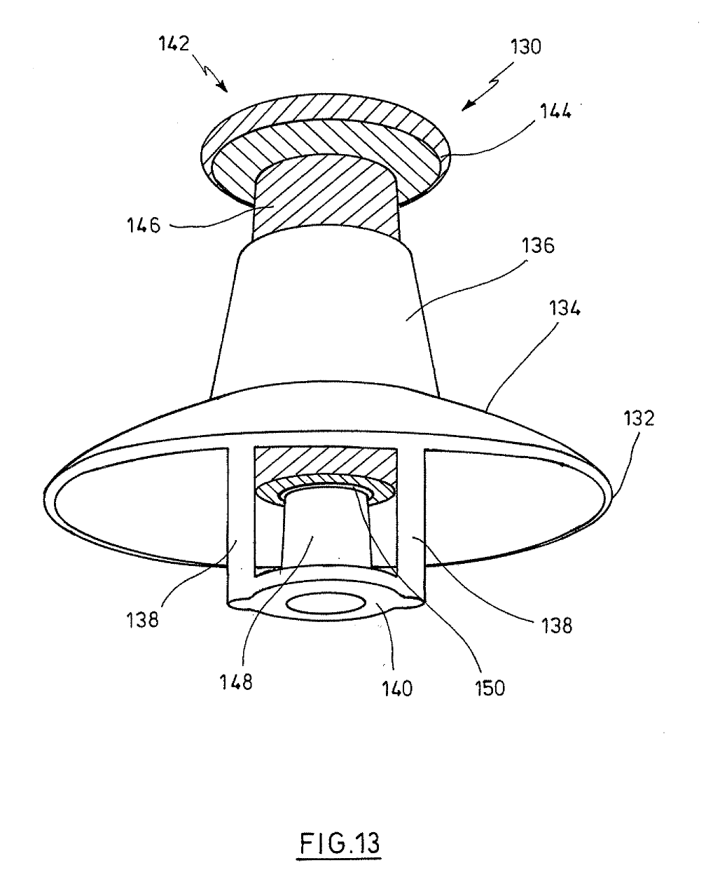

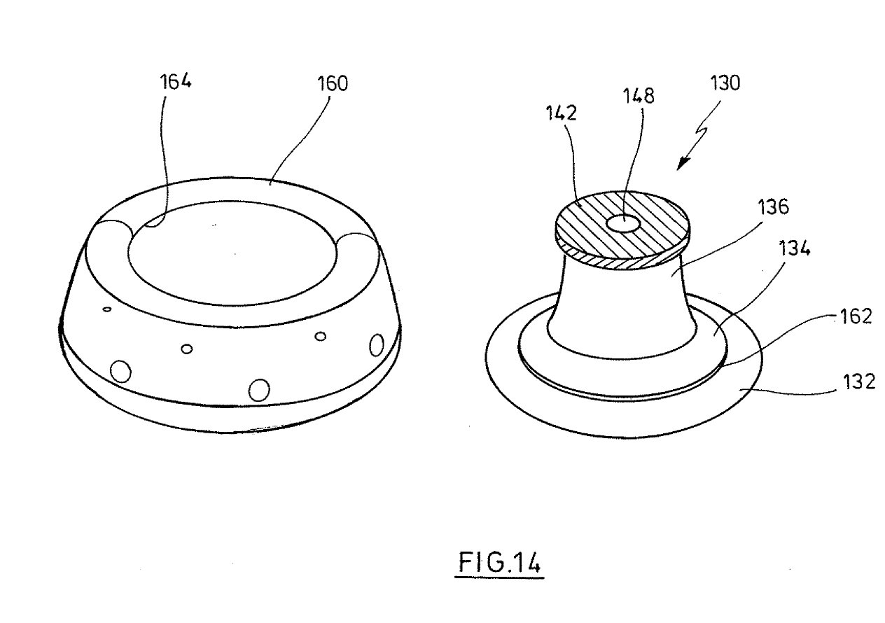

FIG. 13 shows the mouthpiece 130 with the displaceable closure element 142 in a second position, in which the drinking aperture is opened. The same reference numerals are used as in FIGS. 13 and 14. Additionally to the features already described in connection with FIG. 12, in the second position of the closure element 142 a cylindrical portion 146 of the closure element 142 is visible, which is formed below the bead 144. Moreover, a pin 148 is visible which is fastened to the annular connecting piece 140 and/or is integrally manufactured therewith and extends in the axial direction into a cylindrical aperture of the displaceable closure element 142. Between the pin 148 and the substantially tubular closure element 142 an annular gap 150 is visible through which the liquid may flow in the second position shown of the closure element.

FIG. 14 provides a further perspective view of the mouthpiece 130, in which the closure element 142 is in the first position shown in FIG. 12. In this closed position and in the view obliquely from above, the engagement of the upper end of the pin 148 in the cylindrical aperture of the closure element 142 is visible. As a result, the drinking aperture is closed. Moreover, in FIG. 14 a sealing ring 160 is shown through which the mouthpiece 130 may be guided from below, a shoulder 162 formed within the conical surface 134 cooperating with an internal periphery 164 of the sealing ring 160. By screwing the sealing ring 160 to the upper container edge of a drinking bottle or a drinking cup the fastening attachment 132 is sealingly clamped between the sealing ring 160 and the container edge.

This completes the description of the preferred and alternate embodiments of the invention. Those skilled in the art may recognize other equivalents to the specific embodiment described herein which equivalents are intended to be encompassed by the claims attached hereto.

1. Closure system for a children's drinking bottle or a children's drinking cup comprising
a sealing ring (20) which has on an external periphery a fastening member (40) for sealingly and releasably connecting to a container edge (16) of a container of the children's drinking bottle or the children's drinking cup, an aperture (36) for receiving a mouthpiece (22) and/or a blind lid (32) and an internal thread (46), which borders the aperture (36) and is arranged at a distance from the aperture and the fastening means (40), and
a fixing insert (30) with a through aperture (60) and an external thread (66) which may be screwed into the internal thread (46) of the sealing ring (20) in order to clamp sealingly a fastening attachment of the mouthpiece (22) and/or the blind lid (32) between the fixing insert (30) and the sealing ring (20),
wherein the fixing insert (30) has an annular portion (56) which forms the through aperture (60) and a web (58) spanning the through aperture (60).

2. Closure system according to claim 1, characterized in that the internal thread (46) of the sealing ring (20) is formed on a tubular portion (42) of the sealing ring (20), an outer face (44) of the tubular portion being adjacent to an inner face of the container edge (16).

3. Closure system according to claim 1, in which the fixing insert (30) is arranged on the side of the sealing ring (20) facing the container.

4. Closure system according to claim 3, characterized in that one side of the annular portion (56) of the fixing insert facing the container in the state screwed into the sealing ring (20), is terminated approximately flush with a free end of the tubular portion (42) of the sealing ring (20).

5. Closure system according to claim 3, characterized in that one side (64) of the annular portion (56) of the fixing insert (30) facing the container in the assembled state is inclined towards the through aperture (60) in the direction of the mouthpiece (22).

6. Closure system according to claim 1, characterized in that one surface (48) of the sealing ring (20) facing in the assembled state the fastening portion of the mouthpiece and/or one surface of the fixing insert (30) facing the fastening portion of the mouthpiece has a peripheral raised portion, a peripheral edge (54, 68) or a peripheral web (50, 70) which is pressed when screwing-in the fixing insert (30) against the fastening portion.

7. Closure system according to claim 1, characterized in that the internal thread (46) of the sealing ring (20) and the external thread (66) of the fixing insert (30) are designed such that fully screwing-in the fixing insert (30) requires one or two turns.

8. Closure system according to claim 1, characterized in that the fastening member (40) of the sealing ring (20) is a further internal thread (40), which cooperates with an external thread (12) of the container edge.

9. Closure system according to claim 1, characterized in that a blind lid (32) is provided which closes an aperture (36) of the closure system.

10. Closure system according to claim 1, characterized in that it comprises a mouthpiece (22) which has a drinking aperture (34) and a fastening attachment and may be inserted into the aperture (36) of the sealing ring (20).

11. Closure system according to claim 10, characterized in that the mouthpiece (22) is a drinking teat or a drinking spout (22).

12. Closure system according to claim 10, characterized in that the mouthpiece (100) comprises an axially displaceable closure element (104) which sealingly closes the drinking aperture in a first position and opens the drinking aperture in a second position.

13. Closure system according to claim 12, characterized in that the closure element (104) has a peripheral bead (124).

14. Closure system according to claim 12, characterized in that the closure element (104) is of substantially tubular configuration and the mouthpiece (100) has a pin (112) which engages in the first position in a longitudinal portion (110) of the closure element (104).

15. Children's drinking bottle or cup comprising a container (10) which has a container aperture and a container edge (16) and a closure system according to claim 1.

16. Children's drinking bottle or cup according to claim 12, characterized in that a grip element (24) is provided, which is inserted between the container (10) and the sealing ring (20), is configured integrally with the container or is fastened to a separate fastening member on the container.

17. Children's drinking bottle or cup according to claim 12, characterized in that a sealing cap is provided which may be releasably connected to the sealing ring (20) and covers the mouthpiece (22).

18. Closure system for a drinking bottle or a drinking cup with a mouthpiece (130), which comprises
a drinking aperture and
an axially displaceable closure element (142) which sealingly closes the drinking aperture in a first position and opens the drinking aperture in a second position, characterized in that
the mouthpiece (130) comprises a fastening attachment (132) which may be clamped between a container edge of the drinking bottle or the drinking cup and a sealing ring (160) which may be screwed to the drinking bottle or the drinking cup.

19. Closure system according to claim 18, characterized in that the closure element (142) has a peripheral bead (144).

20. Closure system according to claim 18, characterized in that the closure element (142) is of substantially tubular configuration and the mouthpiece (130) has a pin (148) which in the first position engages in a longitudinal portion of the closure element (142).

21. Closure system according to claim 18, characterized in that the fastening portion (132) is a peripheral fastening flange, the thickness thereof reducing outwardly in the radial direction.

22. Drinking bottle or cup comprising a container and a closure system, characterized in that the closure system is designed according to claim 18.

23. Drinking bottle or cup according to claim 21, characterized in that it is a children's drinking bottle or a children's drinking cup.
